(19) United States
(12) Patent Application Publication
(10) Pub. No.: US 2020/0132380 A1
(43) Pub. Date: Apr. 30, 2020

(54) MULTI-CORE RADIATOR WITH INTERMEDIATE TANK

(71) Applicant: DENSO International America, Inc., Southfield, MI (US)

(72) Inventor: Daniel Mark STEPHENS, Ferndale, MI (US)

(21) Appl. No.: 16/171,852

(22) Filed: Oct. 26, 2018

(51) Int. Cl. F28D 1/03; F28F 9/02; F02M 26/32; F28F 3/08

(52) U.S. Cl. CPC F28D 1/0341; F28F 9/0253; F28D 2021/0084; F28F 3/08; F02M 26/32

(57) ABSTRACT

A heat exchanger for several applications such as a vehicle is described herein. The heat exchanger includes an inlet header tank configured to receive a fluid, an outlet header tank configured to output the fluid, and an intermediate tank between the inlet header tank and the outlet header tank. A first heat exchanger is between the inlet header tank and the intermediate tank, and a second heat exchanger is between the intermediate tank and the outlet header tank. The intermediate tank has an interior region having a plurality of protuberances disposed therein. The protuberances are configured to facilitate mixing of the fluid within the intermediate tank. The mixing of the fluid with the protuberances provides a more uniform heat distribution within the intermediate tank before entering the second heat exchanger.

### TECHNICAL FIELD

The present disclosure relates to a heat exchanger, such as a radiator, in an automotive vehicle. In particular, the heat exchanger is provided with an intermediate tank between an inlet tank and an outlet tank.

### BACKGROUND

Heat exchangers can be used to cool or heat associated components within a vehicle. For example, radiators cool engine fluid (e.g., coolant), and condensers cool HVAC fluid. In certain heat exchangers, there may be an inlet tank for receiving the fluid, a core with tubes and fins for performing heat exchange, and an outlet tank. Large temperature differences in adjacent components has a potential for causing strain.

### SUMMARY

According to one embodiment, a heat exchanger for an automotive vehicle includes an inlet header tank, a first heat exchanger core fluidly and mechanically coupled to the inlet header tank, an outlet header tank, and a second heat exchanger core fluidly and mechanically coupled to the outlet header tank. An intermediate tank is fluidly and mechanically coupled to and between the first heat exchanger core and the second heat exchanger core to transfer fluid therebetween. The intermediate tank has an interior surface with protuberances integrally formed therewith. The protuberances are configured to cause mixing of the fluid as the fluid transfers from the first heat exchanger core to the second heat exchanger core.

In another embodiment, a heat exchanger includes an inlet header tank, a first heat exchanger core having a first plurality of tubes coupled to the inlet header tank, an intermediate tank coupled to the first plurality of tubes, a second heat exchanger core having a second plurality of tubes coupled to the intermediate tank, and an outlet header tank coupled to the second plurality of tubes. The intermediate tank includes protuberances configured to facilitate mixing of fluid within the intermediate tank as the fluid transfers from the first heat exchanger core to the second heat exchanger core.

In yet another embodiment, a heat exchanger includes an inlet header tank configured to receive a fluid, an outlet header tank configured to output the fluid, and an intermediate tank between the inlet header tank and the outlet header tank. The intermediate tank has an interior region having a plurality of protuberances disposed therein. The protuberances are configured to facilitate mixing of the fluid within the intermediate tank.

### BRIEF DESCRIPTION OF THE DRAWINGS

FIG. 1 shows a front view of a heat exchanger, in particular a radiator, according to one embodiment.

FIG. 2 shows a front view of a heat exchanger in which an intermediate tank is provided, according to another embodiment.

FIG. 3 shows a front view of a heat exchanger with an intermediate tank, according to another embodiment.

FIG. 4 shows a front view of a heat exchanger with an intermediate tank, according to yet another embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Terms such as “leading,” “front,” “forward,” “rearward,” etc. are used in this disclosure. These terms are for giving positional context of various components relative to a vehicle in which the heat exchanger resides. For example, the leading or front edge of a component is one that is forward-most in the direction of the front of the vehicle (e.g., the vehicle grille).

Heat exchangers can be used to cool or heat associated components within a vehicle. For example, radiators cool engine fluid (e.g., coolant), and condensers cool HVAC fluid. In certain heat exchangers, there may be an inlet tank for receiving the fluid, a core with tubes and fins for performing heat exchange, and an outlet tank. As the fluid flows through the core, there may be a temperature discrepancy at different regions of the core. For example, the fluid closer to the top portion of the header tank may be hotter than the fluid closer to the bottom portion of the outlet tank. This has a potential for causing strain at the interface between hot and cold tubes in the heat exchanger core, due to different rates of expansion of the tubes. Too much strain on the tubes has the potential to cause cracks in the tubes or their connections with the tanks, which has a possibility for leaking fluid.

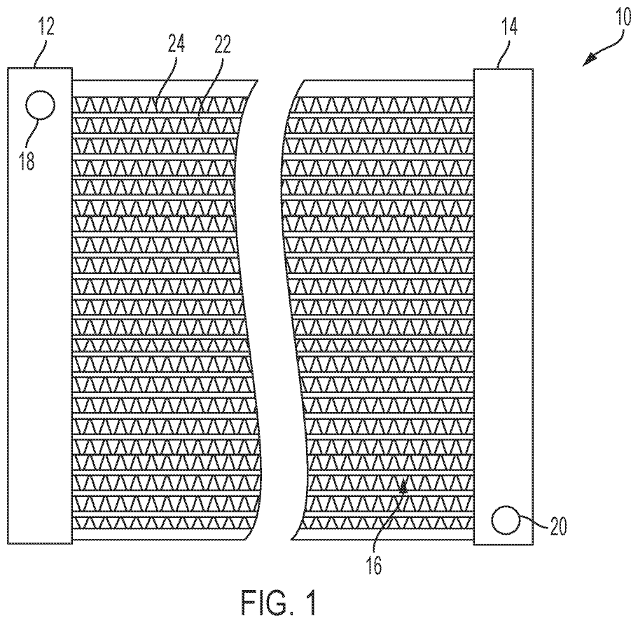

FIG. 1 shows a front view of a radiator 10 according to one embodiment. The radiator is but one type of heat exchanger that the teachings of this disclosure can be applied to, but for the sake of brevity, only a radiator is illustrated. The heat exchanger could also be a condenser, oil cooler, or other heat exchangers known to be located in front of the engine. The radiator 10 includes an inlet header tank 12, an outlet header tank 14, and a core 16 disposed between the inlet header tank 12 and the outlet header tank 14. The inlet header tank 12 defines an inlet 18 through which the coolant enters the radiator 10, and the outlet header tank 14 defines an outlet 20 through which the coolant exits the radiator 10. The core 16 includes a plurality of tubes 22 and a plurality of fins 24 which extend between the inlet header tank 12 and the outlet header tank 14. The tubes 22 fluidly connect the inlet 18 to the outlet 20. The tubes 22 and the fins 24 are arranged in parallel in an alternating pattern such that adjacent tubes 22 are connected in parallel via a fin 24.

Coolant from the engine, which may either be a liquid or gaseous phase, flows from the inlet header tank 12, through the core 16, and to the outlet header tank 14. The core 16 cools the coolant flowing through the radiator 10. More specifically, the coolant flows through the tubes 22, and the fins 24 conduct or transfer heat from the coolant flowing through the tubes 22. Heat transferred to the fins 24 is transferred to air flowing through the radiator 10. The air flowing through the radiator can be supplied naturally when the vehicle is traveling, or via a fan (not shown).

As explained above, there can be a potential for strain at the interface between hot and cold tubes in the heat exchanger core. For example, in the heat exchanger of FIG. 1, the top of the outlet header tank 14 may receive hot coolant before the bottom of the outlet header tank 14 does, due to the hot coolant entering the inlet 18 at the top of the inlet header tank 12. As the entire core heats from top to bottom during a cycle, the interface between the tubes 22 and the outlet header tank 14 also increase in temperature in a direction from top to bottom. During this increase of temperature, the connection between the tubes 22 and the inlet heard tank 12 has the potential to be subjected to increased strain. Too much strain on the tubes has the potential to cause cracks in the tubes or their connections with the tanks, which has a possibility for leaking fluid

Therefore, according to various embodiments disclosed herein, a heat exchanger (such as a radiator) is provided with a center tank or intermediate tank between the inlet header tank and the outlet header tank. The intermediate tank has flow-mixing features for mixing the coolant as it passes from an inlet side to an outlet side of the intermediate tank. This redistributes the temperature of the coolant, resulting in a more neutral temperature fluid in the heat exchanger core. The flow-mixing features can also be referred to as flow diverters or protuberances (e.g., protruding from one direction to another within the intermediate tank).

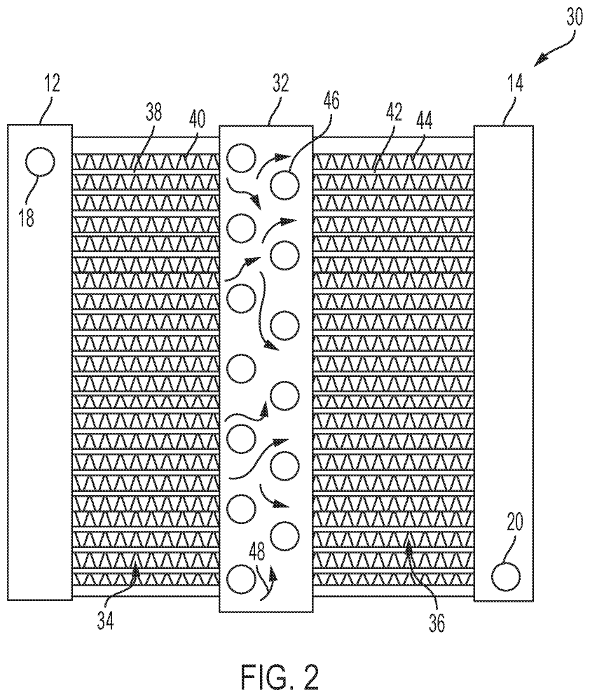

FIG. 2 illustrates a heat exchanger with one example of such an intermediate tank. The radiator or heat exchanger 30 once again includes an inlet header tank 12 and an outlet header tank 14. An intermediate tank 32 is between the inlet header tank 12 and the outlet header tank 14 such that all coolant or fluid that travels from the inlet header tank 12 to the outlet header tank 14 passes through the intermediate tank 32. In particular, a first heat exchanger core 34 connects the inlet header tank 12 to the intermediate tank 32, and a second heat exchanger core 36 connects the intermediate tank 32 to the outlet header tank 14. The first heat exchanger core 34 includes a first plurality of tubes 38 for transferring the fluid from the inlet header tank 12 to the intermediate tank 32, as well as a first plurality of fins 40 for transferring heat. Likewise, the second heat exchanger core 36 includes a second plurality of tubes 42 for transferring the fluid from the intermediate tank 32 to the outlet header tank 14, as well as a second plurality of fins 44 for transferring heat.

The intermediate tank 32 includes a plurality of protuberances or flow-mixing features. Various embodiments of protuberances are illustrated in FIGS. 2-4. Referring to FIG. 2, protuberances 46 are cylindrical protrusions extending normal to the first and second plurality of tubes 38, 42. The protuberances 46 may extend between opposing interior surfaces entirely from front to back of the intermediate tank.

The protuberances 46 may be integrally formed with an interior surface of the intermediate tank 32. For example, the intermediate tank 32 may be formed or bent from a metal blank initially in a two-piece state, and the protuberances 46 may be permanently fixed (e.g., welded, brazed, etc.) to an interior surface of one of the halves of the intermediate tank 32, and the two halves of the intermediate tank 32 can then be permanently fixed to one another. In another embodiment, the protuberances 46 are co-molded with the intermediate tank 32.

The protuberances 46 are configured to mix the coolant or fluid as it travels through the intermediate tank 32. This redistributes the heat of the fluid before entering the second heat exchanger core 36. The mixing of the fluid of shown by arrows 48. In the illustrated embodiment, the coolant exits the first plurality of tubes 38 and enters the intermediate tank 32. Within the intermediate tank 32, the fluid is forced between and around various protuberances 46 such that the fluid comingles and mixes together. Therefore, fluid from one of the tubes 38 mixes with fluid from another one of the tubes 38 within the intermediate tank 32. The protuberances facilitate such mixing in ways that an intermediate tank without protuberances would. For example, as shown in FIG. 2, the cylindrical nature of the protuberances 46 forces at least some of the fluid to turn and flow in various curved directions before entering the second plurality of tubes 42.

The arrangement of the protuberances 46 shown in FIG. 2 is merely an example of one arrangement, namely an arrangement in which the protuberances 46 are staggered in columns going from left to right in the Figure. In other embodiments, the protuberances are stacked in three or more columns. In other embodiments, the protuberances are arranged without uniform in the intermediate tank 32, or in uniform non-staggered columns. Various arrangements of the protuberances are contemplated herein to meet design needs and desired flow characteristics.

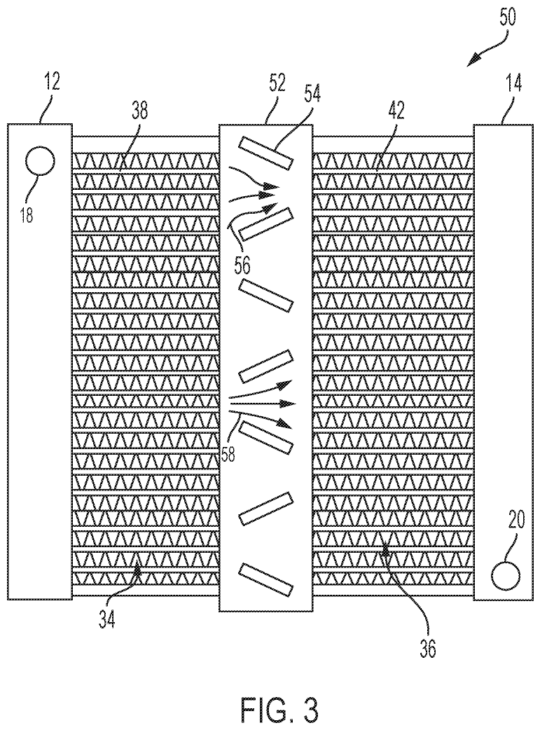

FIG. 3 shows another embodiment of a radiator or heat exchanger 50 with different protuberances. Once again, the heat exchanger 50 includes an inlet header tank 12, an outlet header tank 14, and tubes and fins for each heat exchanger core 34, 36 as in the previous embodiments. The heat exchanger 50 includes an intermediate tank 52 having a plurality of protuberances 54. In this embodiment, the protuberances 54 are have a parallelogram profile (e.g., rectangular) and are protrusions having a length that is angled relative to the direction of the tubes 38, 42.

The angles of the various protuberances may change or alternate to cause various flow-mixing characteristics. For example, a first pair of adjacent protuberances may cause the fluid to converge as shown by arrows 56, forming a restrictive flow path. This can cause the fluid to increase in pressure and/or speed as the fluid travels from the first heat exchanger core 34 toward the second heat exchanger core 36 in the direction of the arrows 56. Meanwhile, a second pair of adjacent protuberances may cause the fluid to diverge as shown by arrows 58, forming an expansive flow path. This can cause the fluid to decrease in pressure and/or speed as the fluid travels from the first heat exchanger core 34 toward the second heat exchanger core 36 in the direction of the arrows 58. The differing pressures and/or speeds of the fluid within the intermediate tank 52 can facilitate mixing of the fluid within the intermediate tank 52, particularly in the region between the protuberances 54 and the second heat exchanger core 36.

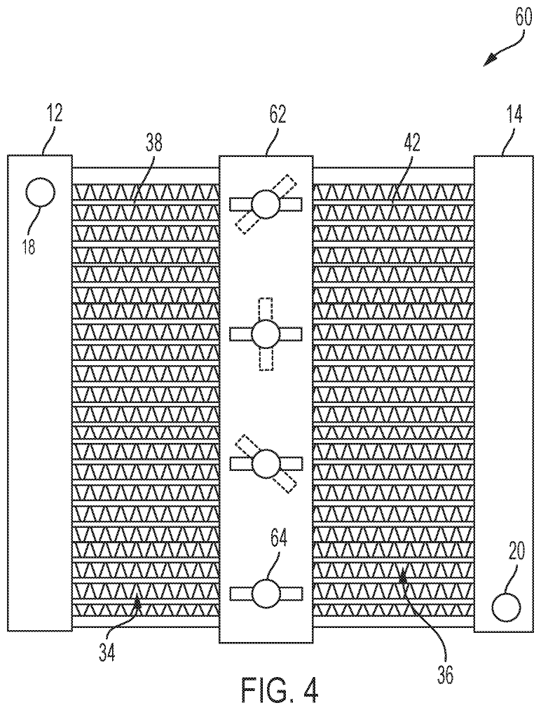

FIG. 4 shows yet another embodiment of a radiator or heat exchanger 60 with different protuberances. Once again, the heat exchanger 60 includes an inlet header tank 12, an outlet header tank 14, and tubes and fins for each heat exchanger core 34, 36 as in the previous embodiments. The heat exchanger 60 includes an intermediate tank 62 between the first heat exchanger core 34 and the second heat exchanger core 36. The heat exchanger 60 also includes protuberances 64 extending from the interior surface of the intermediate tank 62. In this embodiment, the protuberances 64 are moveable protuberances (e.g., butterfly valves) configured to rotate to selectively impede the flow of fluid to selectively route the fluid to different areas of the intermediate tank 62.

For example, the protuberances 64 can rotate to various positions shown with dashed lines in FIG. 4. A controller and actuator (not shown) can be provided to command such movement. The protuberances 64 may be separated by a distance from one another such that even when the valves are all rotated to a closed position (indicated at 66), the fluid can still flow through the intermediate tank 62 between the protuberances 64. In another embodiment, the valves 64 are adjacent to one another such that when adjacent valves are rotated to be in their closed position they cooperate to prevent the fluid from flowing between those adjacent valves. This enables the flow of fluid to be blocked from one or more sections of the intermediate tank 62 and rerouted to another section of the intermediate tank.

The protuberances 64 can be operated and controlled to specifically direct fluid flow to account for various temperature distributions. For example, when the heat exchanger 60 begins operation, hot coolant is pumped through the heat exchanger 60 through the inlet 18. This may cause the region around the inlet 18 (e.g, the upper left corner of the first heat exchanger core 34) to heat first. The distribution of heat travels downward and towards the right as more hot coolant is introduced into the heat exchanger. During this time, the protuberances 64 may be operated to rotate from an open position to a closed position progressively from top to bottom of the intermediate tank. In other words, the uppermost valve 64 may be commanded to close, and then the next uppermost valve may be commanded to close, and so on, as the distribution of heat moves from top to bottom within the heat exchanger 60.

This is but one example of controlled operation of the valves. The valves can operate in various fashions to facilitate the mixing of fluid in the intermediate tank 62. For example, the valves may randomly, or at predetermined intervals, alternate between open and closed to redirect the fluid flow within the intermediate tank 62.

The protuberances 64 can have a portion that extends from the interior surface of the intermediate tank 62. For example, the intermediate tank 62 may have extensions integrally formed with the interior of the intermediate tank 62, and flippers or flaps may extend from the extensions in a rotatable manner.

In any of the embodiments above, at least a portion of the protuberances can be integrally-formed with an interior of the intermediate tank. In other words, the protuberances can be formed, molded, bent, or otherwise made as an integrated extension of the interior surface of the intermediate tank. In other embodiments, the protuberances can be separately attached (e.g., via welding) to the interior surface of the intermediate tank.

The protuberances of this disclosure help to redistribute the temperature of the fluid in the heat exchanger core. Reducing the difference in neighboring tubes in the core reduces the potential strain on the tubes, which increases the durability of the heat exchanger. The protuberances facilitate the mixing of the fluid in ways that an intermediate tank without such protuberances would. For example, fluid can be forced to travel around protrusions, converge, diverge, or otherwise move within the intermediate tank as the fluid travels from one heat exchanger core to the other between the inlet header tank and the outlet header tank.

It should be understood that the embodiments described above can be combined. The intermediate tank can include protuberances of any or all of the embodiments described above.

While the controller is not illustrated in the figures, it should be understood that the controller may include a microprocessor or central processing unit (CPU) in communication with various types of computer readable storage devices or media to perform the task of operating the valves. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the valves.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A heat exchanger for an automotive vehicle, the heat exchanger comprising:
an inlet header tank;
a first heat exchanger core fluidly and mechanically coupled to the inlet header tank;
an outlet header tank;
a second heat exchanger core fluidly and mechanically coupled to the outlet header tank; and
an intermediate tank fluidly and mechanically coupled to and between the first heat exchanger core and the second heat exchanger core to transfer fluid therebetween, the intermediate tank having an interior surface with protuberances integrally formed therewith, wherein the protuberances are configured to cause mixing of the fluid as the fluid transfers from the first heat exchanger core to the second heat exchanger core.

2. The heat exchanger of claim 1, wherein the intermediate tank has front and rear surfaces, and the protuberances extend therebetween.

3. The heat exchanger of claim 2, wherein the protrusions are cylindrical.

4. The heat exchanger of claim 2, wherein the intermediate tank has a top and bottom surface, and the protuberances are arranged in staggered columns from the top surface toward the bottom surface of the intermediate tank.

5. The heat exchanger of claim 1, wherein the protuberances are oriented such that a first pair of protuberances are angled toward one another and a second pair of protuberances are angled away from one another.

6. The heat exchanger of claim 1, wherein the protuberances include a first pair of protuberances that form a restrictive flow path, and a second pair of protuberances that form an expansive flow path.

7. The heat exchanger of claim 1, wherein the protuberances include valves configured to move between an open position and a closed position.

8. The heat exchanger of claim 7, wherein the valves when in the closed position only partially inhibit the transfer of fluid from the first heat exchanger core to the second heat exchanger core.

9. The heat exchanger of claim 1, wherein the first heat exchanger includes a first plurality of tubes configured to transfer the fluid from the inlet header tank to the intermediate tank, and the second heat exchanger includes a second plurality of tubes configured to transfer the fluid from the intermediate tank to the outlet header tank.

10. A heat exchanger comprising:
an inlet header tank;
a first heat exchanger core having a first plurality of tubes coupled to the inlet header tank;
an intermediate tank coupled to the first plurality of tubes;
a second heat exchanger core having a second plurality of tubes coupled to the intermediate tank; and
an outlet header tank coupled to the second plurality of tubes;
wherein the intermediate tank includes protuberances configured to facilitate mixing of fluid within the intermediate tank as the fluid transfers from the first heat exchanger core to the second heat exchanger core.

11. The heat exchanger of claim 10, wherein the protuberances are integrally-formed with an interior surface of the intermediate tank.

12. The heat exchanger of claim 10, wherein the protuberances include a plurality of protrusions extending across the intermediate tank from a font side of the intermediate tank to a rear side of the intermediate tank.

13. The heat exchanger of claim 12, wherein the plurality of protrusions are arranged in a staggered orientation.

14. The heat exchanger of claim 10, wherein the protuberances includes a first pair of protuberances configured to increase a speed of a first portion of the fluid as it flows through the intermediate tank, and a second pair of protuberances configured to decrease the speed of a second portion of the fluid as it flows through the intermediate tank.

15. The heat exchanger of claim 10, wherein the protuberances are moveable within the intermediate tank.

16. The heat exchanger of claim 15, wherein the protuberances are valves configured to move between an open position and a closed position.

17. A heat exchanger comprising:
an inlet header tank configured to receive a fluid;
an outlet header tank configured to output the fluid; and
an intermediate tank between the inlet header tank and the outlet header tank, the intermediate tank having an interior region having a plurality of protuberances disposed therein, wherein the protuberances are configured to facilitate mixing of the fluid within the intermediate tank.

18. The heat exchanger of claim 17, wherein the protuberances extend across the intermediate tank from a front side of the intermediate tank toward a rear side of the intermediate tank.

19. The heat exchanger of claim 17, wherein the protuberances are moveable within the intermediate tank.

20. The heat exchanger of claim 17, further comprising a first heat exchanger core having a first plurality of tubes configured to transfer the fluid from the inlet header tank to the intermediate tank whereupon the fluid is mixed, and a second heat exchanger core having a second plurality of tubes configured to transfer the mixed fluid from the intermediate tank to the outlet header tank.
